(19) United States
(12) Patent Application Publication
(10) Pub. No.: US 2024/0354999 A1
(43) Pub. Date: Oct. 24, 2024

(54) SCENE ENCODING GENERATING APPARATUS, METHOD, AND NON-TRANSITORY COMPUTER READABLE STORAGE MEDIUM

(71) Applicants: HON HAI PRECISION INDUSTRY CO., LTD., New Taipei City (TW); Foxconn Technology Group Co., Ltd., Guangdong Province (CN)

(72) Inventors: Zi-Kang ZHOU, New Taipei City (TW); Jian-Ping WANG, New Taipei City (TW); Yung-Hui LI, New Taipei City (TW)

(21) Appl. No.: 18/633,532

(22) Filed: Apr. 12, 2024

Related U.S. Application Data
(60) Provisional application No. 63/496,960, filed on Apr. 19, 2023.

(51) Int. Cl. G06T 9/00; G06T 7/20; G06T 7/70

(52) U.S. Cl. CPC G06T 9/00; G06T 7/20; G06T 7/70

(57) ABSTRACT

A scene encoding generating apparatus is configured to execute the following operations. The scene encoding generating apparatus generates a local coordinate system based on a position and a movement state corresponding to each of a plurality of obstacles in a time point. The scene encoding generating apparatus transforms the position and the movement state corresponding to each of the obstacles to the corresponding local coordinate system to generate a local position and a local movement state. The scene encoding generating apparatus generates an obstacle tensor corresponding to the obstacles based on the local positions and the local movement states corresponding to the obstacles, wherein the obstacle tensor is corresponding to the time point. The scene encoding generating apparatus inputs the obstacle tensor into a scene encoder to generate a scene encoding, wherein the scene encoding is configured to be inputted into a decoder to generate a trajectory prediction.

### CROSS-REFERENCE TO RELATED APPLICATION

This application claims priority to U.S. Provisional Application Ser. No. 63/496,960, filed Apr. 19, 2023, which is herein incorporated by reference in its entirety.

### BACKGROUND

### Field of Invention

The present disclosure relates to a scene encoding generating apparatus. More particularly, the present disclosure relates to a traffic scene encoding generating apparatus.

### Description of Related Art

Trajectory prediction is one of the key technologies of self-driving cars. In order to obtain driving environment information and further control the vehicle to ensure the safety of the vehicle and passengers, it is necessary to capture the scene information of the vehicle in real time and input it into the prediction model for calculation and prediction.

However, as the number of objects in the scene (e.g., other vehicles and/or pedestrians near the self-driving car) increases, the scene information also increases. This will increase the calculation time when retrieving scene information, thereby reducing prediction efficiency.

In view of this, how to capture scene information more efficiently is the goal that the industry strives to work on.

### SUMMARY

The disclosure provides a scene encoding generating apparatus comprises a communication interface and a processor. The processor is coupled to the communication interface and configured to execute the following operations: receiving a position and a movement state in a first time point of each of a plurality of obstacles; generating a local coordinate system corresponding to each of the obstacles based on the position and the movement state corresponding to each of the obstacles; transforming the position and the movement state corresponding to each of the obstacles into the local coordinate system of the corresponding obstacle to generate a local position and a local movement state of the corresponding obstacle; generating a first obstacle tensor corresponding to the obstacles based on the local positions and the local movement states corresponding to the obstacles, wherein the first obstacle tensor corresponds to the first time point; and inputting the first obstacle tensor into a scene encoder to generate a first scene encoding, wherein the first scene encoding corresponds to the first time point corresponding to the first obstacle tensor, and the first scene encoding is configured to be inputted into a decoder to generate a trajectory prediction corresponding to the obstacles.

The disclosure further provides a scene encoding generating method, being adapted for use in a scene encoding generating apparatus, wherein the scene encoding generating method comprises the following steps: receiving, by the scene encoding generating apparatus, a position and a movement state in a first time point of each of a plurality of obstacles; generating, by the scene encoding generating apparatus, a local coordinate system corresponding to each of the obstacles based on the position and the movement state corresponding to each of the obstacles; transforming, by the scene encoding generating apparatus, the position and the movement state corresponding to each of the obstacles into the local coordinate system of the corresponding obstacle to generate a local position and a local movement state of the corresponding obstacle; generating, by the scene encoding generating apparatus, a first obstacle tensor corresponding to the obstacles based on the local positions and the local movement states corresponding to the obstacles, wherein the first obstacle tensor corresponds to the first time point; and inputting, by the scene encoding generating apparatus, the first obstacle tensor into a scene encoder to generate a first scene encoding, wherein the first scene encoding corresponds to the first time point corresponding to the first obstacle tensor, and the first scene encoding is configured to be inputted into a decoder to generate a trajectory prediction corresponding to the obstacles.

The disclosure further provides a non-transitory computer readable storage medium, having a computer program stored therein, wherein the computer program comprises a plurality of codes, the computer program executes a scene encoding generating method after being loaded into an electronic apparatus, the scene encoding generating method comprises: receiving, by the electronic apparatus, a position and a movement state in a first time point of each of a plurality of obstacles; generating, by the electronic apparatus, a local coordinate system corresponding to each of the obstacles based on the position and the movement state corresponding to each of the obstacles; transforming, by the electronic apparatus, the position and the movement state corresponding to each of the obstacles into the local coordinate system of the corresponding obstacle to generate a local position and a local movement state of the corresponding obstacle; generating, by the electronic apparatus, a first obstacle tensor corresponding to the obstacles based on the local positions and the local movement states corresponding to the obstacles, wherein the first obstacle tensor corresponds to the first time point; and inputting, by the electronic apparatus, the first obstacle tensor into a scene encoder to generate a first scene encoding, wherein the first scene encoding corresponds to the first time point corresponding to the first obstacle tensor, and the first scene encoding is configured to be inputted into a decoder to generate a trajectory prediction corresponding to the obstacles.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a trajectory prediction model according to some embodiments of the present disclosure.

FIG. 2 is a schematic diagram illustrating a scene encoder in the prior art.

FIG. 3 is a schematic diagram illustrating a scene encoding generating apparatus according to a first embodiment of the present disclosure.

FIG. 4 is a schematic diagram illustrating a position and a movement state of an obstacle in an original coordinate system according to some embodiments of the present disclosure.

FIG. 5 is a schematic diagram illustrating the position and the movement state of the obstacle being transformed into a local coordinate system according to some embodiments of the present disclosure.

FIG. 6 is a schematic diagram illustrating a scene encoder according to some embodiments of the present disclosure.

FIG. 7 is a schematic diagram illustrating a scene encoding generating method according to a second embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

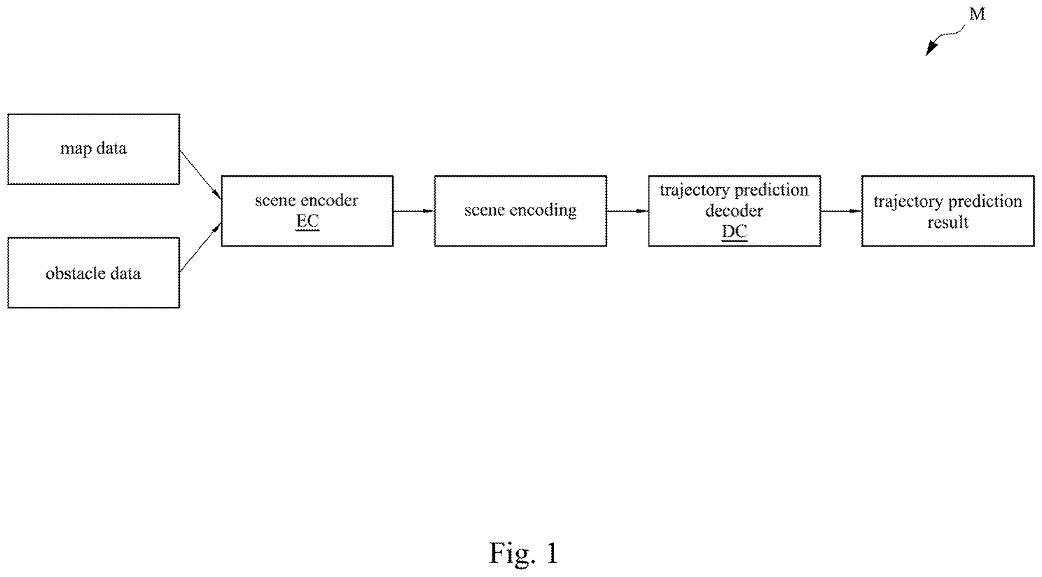

Please refer to FIG. 1, which is a schematic diagram illustrating a trajectory prediction model according to some embodiments of the present disclosure. For performing a trajectory prediction, obstacle data and map data are needed to be obtained first. The obstacle data is configured to represent the status of each of the obstacles in the scene. For example, the obstacle data may comprise positions, speeds, orientations, and other information of each of the obstacles in the scene at several time points. The map data is configured to represent the map information in the scene. In some embodiments, the obstacle data and the map data are represented in the form of tensors.

After obtaining the obstacle data and the map data, a scene encoder EC generates a scene encoding based on the obstacle data and the map data. Since the original obstacle data and map data do not comprise the relationships between each of the obstacles and the map objects at each of the time points, the scene encoder EC takes the obstacle data and the map data as an input to encode, and the outputted scene encoding is able to record the relationships between each of the obstacles and the map objects at each of the time points. In some embodiments, the scene encoder EC is an attention-based encoder.

After generating the scene encoding, a trajectory prediction decoder DC is able to decode the relationships between each of the obstacles and the map objects at each of the time points record by the scene encoding and generate a trajectory prediction result, wherein the trajectory prediction result may comprise possible movement route, speed, orientation, and other information of each of the obstacles in the scene. In some embodiments, the trajectory prediction decoder DC is a decoder corresponding to the scene encoder EC.

After generating the trajectory prediction result, the trajectory prediction result can be used for subsequent applications. For example, self-driving cars executes applications such as determining whether the vehicle itself poses an accident risk, calculating the risk, and planning the optimization path based on the movement state of each of the obstacles in the trajectory prediction result, thereby controlling the self-driving cars.

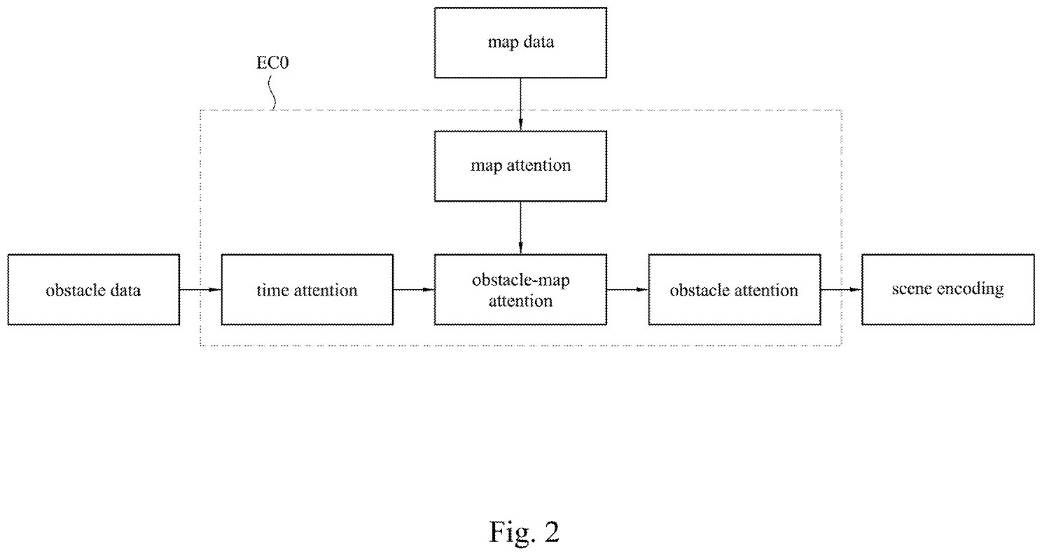

As for the details about the scene encoder, please refer to FIG. 2, which is a schematic diagram illustrating a scene encoder EC0 in the prior art. As shown in FIG. 2, the scene encoder EC0 comprises a time attention, a map attention, an obstacle-map attention, and an obstacle attention.

The time attention is configured to perform a self-attention calculation based on obstacle data to generate an output tensor.

In some embodiments, assuming the obstacle data is a tensor in a size of [A,T,D], wherein A is a number of obstacles referred by the obstacle data, T is a number of time points referred by the obstacle data, and D is a preset embedding dimension (i.e., 128). The time attention transforms the obstacle data into query vectors, key vectors, and value vectors in the self-attention calculation. Accordingly, since the [A,T,D] tensor (i.e., the obstacle data) is transformed into the query vectors, the key vectors, and the value vectors for calculations, the time complexity of the time attention is O(AT²), and the output tensor of the time attention is a [A,T,D] tensor.

The map attention is configured to perform a self-attention calculation based on map data to generate an output tensor.

In some embodiments, assuming the map data is a tensor in a size of [M,D], wherein M is a number of objects referred by the map data, and D is a preset embedding dimension (i.e., 128). The map attention transforms the map data into query vectors, key vectors, and value vectors in the self-attention calculation. Accordingly, since the [M,D] tensor (i.e., the map data) is transformed into the query vectors, the key vectors, and the value vectors for calculations, the time complexity of the map attention is O(M²), and the output tensor of the map attention is a [M,D] tensor.

The obstacle-map attention is configured to perform an attention calculation based on the output tensors of the time attention and the map attention to generate an output tensor.

In some embodiments, when the output tensor of the time attention is a [A,T,D] tensor, and the output tensor of the map attention is a [M,D] tensor, the obstacle-map attention transforms the output tensor of the time attention into query vectors in the attention calculation and transforms the output tensor of the map attention into key vectors and value vectors in the attention calculation. Accordingly, since the [A,T,D] tensor (i.e., the output tensor of the time attention) is transformed into the query vectors and the [M,D] tensor (i.e., the output tensor of the map attention) is transformed into the key vectors and the value vectors for calculations, the time complexity of the time attention is O(ATM), and the output tensor of the obstacle-map attention is a [A,T,D] tensor.

The obstacle attention is configured to perform a self-attention calculation based on the output tensor of the obstacle-map attention to generate an output tensor.

In some embodiments, when the output tensor of the obstacle-map attention is a [A,T,D] tensor, the obstacle attention transforms the output tensor of the obstacle-map attention query vectors, key vectors, and value vectors in the self-attention calculation. Accordingly, since the [A,T,D] tensor (i.e., the output tensor of the obstacle-map attention) is transformed into the query vectors, the key vectors, and the value vectors for calculations, the time complexity of the time attention is O(A²T), and the output tensor of the obstacle attention is a [A,T,D] tensor.

Finally, as shown in FIG. 2, the output of the obstacle attention can be taken as a scene encoding. The scene encoding is configured to be inputted into a corresponding trajectory prediction decoder (e.g., the trajectory prediction decoder DC shown in FIG. 1) to generate a trajectory prediction result corresponding to the obstacles in the scene based on information in the scene, and the time complexity of calculating the scene encoding is O(AT²+M²+ATM+A²T).

It is noticed that, the position and the movement state of each of the obstacles at the same time point in the obstacle data are based on the same coordinate system. For example, in the obstacle data captured at a time point t=0 by a self-driving car, the obstacles in the scene are positioned based on a coordinate system formed with the position of the self-driving car at the time point t=0 as the origin and the orientation the self-driving car faces as the X-axis. Namely, the obstacle data represents the positions and the movement states of the obstacles at the time point t=0 based on the coordinate system defined by the position and the movement state of the self-driving car at the time point t=0. Similarly, in the obstacle data captured at a next time point t=1 by the self-driving car, the obstacles in the scene are positioned based on a coordinate system formed with the position of the self-driving car at the time point t=1 as the origin and the orientation the self-driving car faces as the X-axis. Namely, the obstacle data represents the positions and the movement states of the obstacles at the time point t=1 based on the coordinate system defined by the position and the movement state of the self-driving car at the time point t=1.

However, the references of the coordinate systems at different time points may change (e.g., the self-driving car moves causing the positions and the orientations at different time points to change). In order to make obstacle data corresponding to different time points related to each other, before being inputted into the scene encoder for calculation, the coordinate systems needs to be normalized for the obstacle data corresponding to different time points. Specifically, the positions and the movement states such as orientations and speeds corresponding to multiple time points in the obstacle data can be represented based on the coordinate system corresponding to the latest time point.

Accordingly, although the coordinate systems can be unified to make the information corresponding to different time points related to each other through attention calculation, the coordination systems need to be normalized again whenever new obstacle data has been inputted. Furthermore, in the technical field of trajectory prediction, the acquisition of obstacle data and the generation of trajectory predictions are streaming. Specifically, the obstacle data has to be captured constantly, and the trajectory predictions also have to be performed constantly when the self-driving car is operating.

For example, a self-driving car refers to the obstacle data and the map data in the past 5000 milliseconds and samples every 100 milliseconds (i.e., generating the obstacle data and the map data corresponding to the current time point every 100 milliseconds) when performing trajectory predictions. Namely, obstacle data and map data corresponding to 50 time points need to be referred in every trajectory predictions. However, as mentioned before, although the obstacle data and the map data corresponding to time points in the past (i.e., the obstacle data and the map data corresponding to the 49 time points in the past) have been transformed into a scene encoding by the encoder through the previous trajectory predictions, the scene encoding is based on different coordinate system from the latest obstacle data and map data. Therefore, when new obstacle data and map data has been inputted for trajectory predictions, the scene encoding cannot be used for the latest trajectory prediction.

In summary, among the existing trajectory prediction technologies, not only the coordinate systems corresponding to different time points need to be normalized in every trajectory predictions, but also the scene encodings have to be recalculated for each of the time points, making it difficult to improve the calculation efficiency.

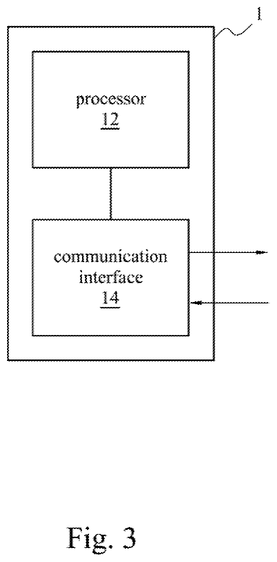

Therefore, the present disclosure provides a scene encoding generating apparatus, please refer to FIG. 3, which is a schematic diagram illustrating a scene encoding generating apparatus 1 according to a first embodiment of the present disclosure. The scene encoding generating apparatus 1 is configured to generate a scene encoding based on obstacle data and map data in the scene by using a scene encoder.

As shown in FIG. 3, the scene encoding generating apparatus 1 comprises a processor 12 and a communication interface 14, wherein the processor 12 is coupled to the communication interface 14. The processor 12 is configured to execute a scene encoding calculation. The communication interface 14 is configured to receive obstacle data and map data.

In some embodiments, the processor 12 can comprise a central processing unit (CPU), a graphics processing unit (GPU), a multi-processor, a distributed processing system, an application specific integrated circuit (ASIC), and/or a suitable processing unit.

In some embodiments, the processor 12 communicatively connects to an external apparatus to receive the obstacle data and the map data, and the external apparatus can be a camera, a radar transceiver, a lidar transceiver, or other apparatus on a vehicle capturing positions and movement states of the obstacles and objects in the scene.

First, the processor 12 of the scene encoding generating apparatus 1 receives a position and a movement state in a first time point of each of a plurality of obstacles via the communication interface 14.

Similarly, the processor 12 receives a position coordinate, an orientation, and a speed of each of the obstacles in the scene, wherein the obstacles may comprise objects such as the self-driving car itself, other vehicles in the scene, and pedestrians. In some embodiments, the processor 12 receives a position and a movement state of each of the obstacles at the current time point, and the positions and the movement states are represented as a tensor in a size of [A, 1,5], wherein A is a number of obstacles, and position coordinates (having a dimension of 2), orientations (having a dimension of 1), and speeds (having a dimension of 2) (e.g., a position coordinate is (2,2), an orientation is π/2, and a speed is (−1,3)) form 5-dimensional data.

Next, the processor 12 generates a local coordinate system corresponding to each of the obstacles based on the position and the movement state corresponding to each of the obstacles and transforms the position and the movement state corresponding to each of the obstacles into the local coordinate system of the corresponding obstacle to generate a local position and a local movement state of the corresponding obstacle.

In order to solve the problem that the coordinate systems need to be normalized and the scene encoding need to be calculated repeatedly, the scene encoding generating apparatus 1 represents the position and the movement state of an obstacle based on a local coordinate system established by using its own position and movement state.

Specifically, the processor 12 generates a local coordinate system by using the position and the movement state of each of the obstacles and transforms the position and the movement state to the corresponding local coordinate system. Namely, for each of the obstacles, the processor 12 generates a corresponding local coordinate system and transforms the positions and the movement states of the obstacles into the corresponding local coordinate system.

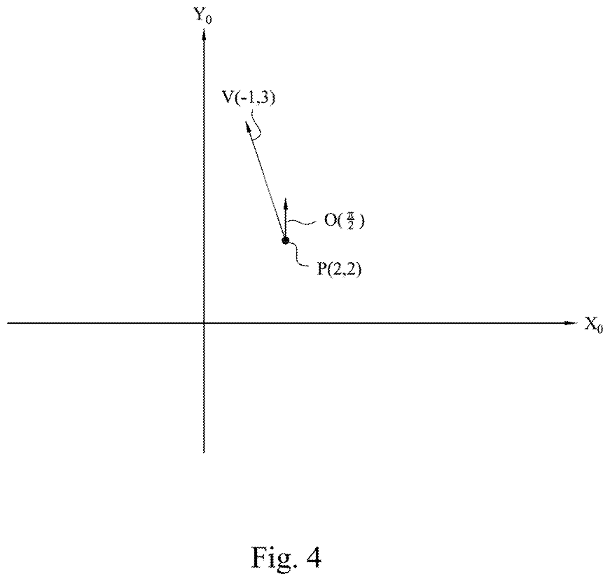

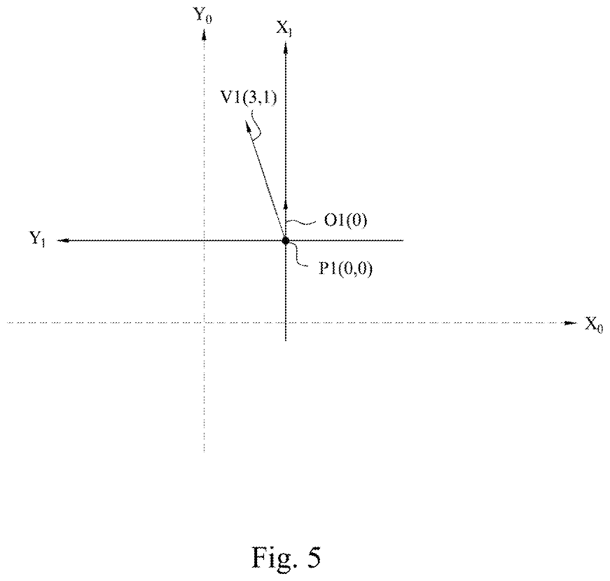

As for the details about generating and transforming into the local coordinate system, please refer to FIGS. 4 and 5, wherein FIG. 4 is a schematic diagram illustrating a position and a movement state of an obstacle in an original coordinate system according to some embodiments of the present disclosure, and FIG. 5 is a schematic diagram illustrating the position and the movement state of the obstacle being transformed into a local coordinate system according to some embodiments of the present disclosure.

As shown in FIG. 4, the position coordinate P is (2,2), the orientation O is π/2, and the speed V is (−1,3) of the obstacle in the original coordinate system (e.g., taking the position of a self-driving car as the origin and taking the orientation of the self-driving car as the x₀ axis).

Furthermore, as shown in FIG. 5, the processor 12 takes the position coordinate P of the obstacle as the origin of the local coordinate system and takes the orientation O of the obstacle as the x₁ axis of the local coordinate system. Accordingly, the transformed position coordinate P1 is (0,0), the transformed orientation O1 is 1, and the transformed speed V1 is (3,1).

It is noted that, FIGS. 4 and 5 are an example of transforming into a local coordinate system, and the processor 12 may transform the position and the movement state of each of the obstacles through the same operation.

Next, the processor 12 generates a first obstacle tensor corresponding to the obstacles based on the local positions and the local movement states corresponding to the obstacles, wherein the first obstacle tensor corresponds to the first time point.

In some embodiments, the processor 12 transforms the local positions and the local movement states in a size of [A,1,5] into the first obstacle tensor in a size of [A,1,D] by using a 3-layer Multilayer Perceptron (3-layer MLP), wherein D is a preset embedding dimension (i.e., 128). The first obstacle tensor is configured to represent the feature of the positions and the movement states of the obstacles in the scene based on the local coordinate system.

Finally, the processor 12 inputs the first obstacle tensor into a scene encoder to generate a first scene encoding, wherein the first scene encoding corresponds to the first time point corresponding to the first obstacle tensor, and the first scene encoding is configured to be inputted into a decoder to generate a trajectory prediction corresponding to the obstacles.

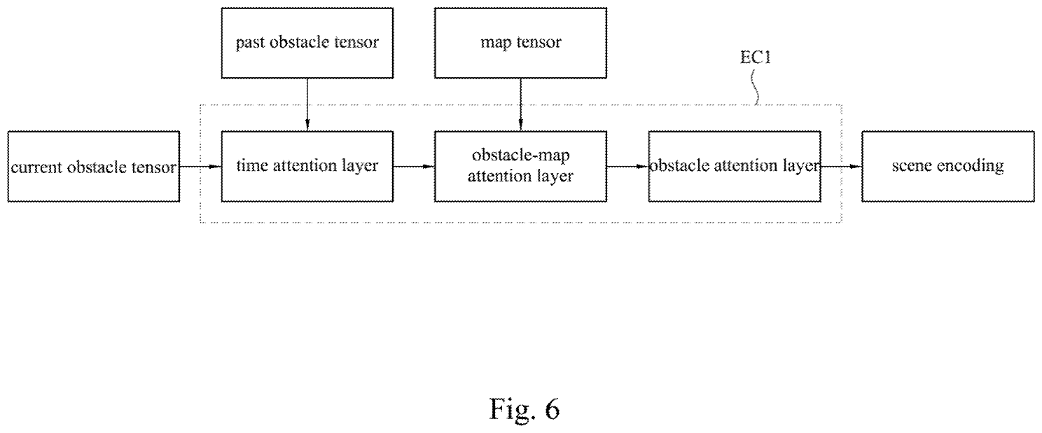

As for the specific details about the scene encoder, please refer to FIG. 6, which is a schematic diagram illustrating a scene encoder EC1 according to some embodiments of the present disclosure. The scene encoder EC1 can be executed by the scene encoding generating apparatus 1. As shown in FIG. 6, the scene encoder EC1 comprises a time attention layer, an obstacle-map attention layer, and an obstacle attention layer.

The time attention layer is configured to perform attention calculation based on a current obstacle tensor and a past obstacle tensor to generate an output tensor. The current obstacle tensor can be the aforementioned first obstacle tensor, namely, an obstacle tensor generated by using the positions and the movement states corresponding to the current time point. The past obstacle tensor can be an obstacle tensor generated by using the positions and the movement states obtained in the past (e.g., in the past 5 seconds), namely, the obstacle tensor relatively earlier than the current obstacle tensor.

In some embodiments, in the perspective of the time attention layer, the current obstacle tensor is the first input tensor corresponding to the first time point, and the past obstacle tensor is the second input tensor corresponding to the second time point, wherein the second time point is earlier than the first time point.

For example, if the scene encoding generating apparatus 1 receives a set of the position and the movement state corresponding to the latest time point every 100 milliseconds and performs a trajectory prediction based on the positions and the movement states received in the past 5000 milliseconds, the scene encoding generating apparatus 1 takes a set of the position and the movement state corresponding to the latest time point as the current obstacle tensor and takes 49 sets of the position and the movement state corresponding to the earlier time points as the past obstacle tensor.

The output tensor of the time attention layer represents relationships between movement states at multiple time points of obstacles. Assume that the current obstacle tensor is a tensor in a size of [A,1,D], and the past obstacle tensor is a tensor in a size of [A,T−1,D], wherein A is a number of obstacles referred by the obstacle data, T is a number of time points referred by the current trajectory prediction (i.e., comprising 1 time point of the current obstacle tensor and T−1 time points of the past obstacle tensor), and D is a preset embedding dimension (i.e., 128).

It is noted that, in some embodiments, the processor 12 transforms the current obstacle tensor into query vectors in the attention calculation of the time attention layer and transforms the past obstacle tensor into key vectors and value vectors in the attention calculation of the time attention layer. Also, the processor 12 performs the attention calculation of the time attention layer based on the query vectors, key vectors, and value vectors. Accordingly, since the tensor with only [A,1,D] size (i.e., the current obstacle tensor) is transformed into the query vectors and the [A,T−1,D] tensor (i.e., the past obstacle tensor) is transformed into the key vectors and the value vectors for the attention calculation, the time complexity of the time attention layer is O(AT), and the output tensor of the time attention layer is a [A,1,D] tensor.

In some embodiments, when the time attention layer transforms data of an i-th obstacle in the current obstacle tensor (i.e., a [1,1,D] vector corresponding to the i-th obstacle in the [A,1,D] current obstacle tensor) into a query vector to perform an attention calculation, the processor 12 calculates the corresponding key vector and value vector by the following formula 1.

$${\{ [ {a}_{i}^{s} ; {r}_{i \to i}^{s \to t} ] \}}_{s = t - τ}^{t - 1} , \qquad ( formula 1 )$$

Wherein aᵢ^{s} is a vector of the i-th obstacle corresponding to an s-th time point in the past obstacle tensor, r_{i→i}^{s→t} is a space-time relative relationship of the i-th obstacle between the s-th time point and a t-th time point, and the space-time relative relationship comprises a relative distance, a relative direction, a relative orientation, and a time difference (i.e., s-t).

The obstacle-map attention layer is configured to perform attention calculation based on the output tensor of the time attention layer and a map tensor to generate an output tensor. The output tensor of the obstacle-map attention layer represents relationships between the obstacles and objects in the scene.

In some embodiments, the processor 12 transforms the output tensor of the time attention layer into query vectors in the attention calculation of the obstacle-map attention layer and transforms the map tensor into key vectors and value vectors in the attention calculation of the obstacle-map attention layer. Also, the processor 12 performs the attention calculation of the obstacle-map attention layer based on the query vectors, key vectors, and value vectors. Accordingly, since the tensor with only [A,1,D] size (i.e., the output tensor of the time attention layer) is transformed into the query vectors and the [M,D] tensor (i.e., the map tensor) is transformed into the key vectors and the value vectors for the attention calculation, the time complexity of the obstacle-map attention layer is O(AM), and the output tensor of the obstacle-map attention layer is a [A,1,D] tensor.

In some embodiments, the scene encoding generating apparatus 1 pre-calculate the map tensor based on a digital map. For example, the digital map comprises road markings, road boundaries, and other objects in the map represented by polygons, wherein the processor 12 of the scene encoding generating apparatus 1 establishes a local coordinate system based on a position and a reference line (e.g., a center line) of each of the objects respectively and transforms the polygons of the objects into the corresponding local coordinate system.

Next, the processor 12 then transforms endpoints of the object polygons into an endpoint vector with a preset dimension (e.g., 128) by using 3-layer Multilayer Perceptron.

Next, the processor 12 then samples the endpoint vector of each endpoints of polygons by using a max-pooling layer to obtain a [M,D] tensor, wherein the tensor is formed by polygon vectors corresponding to M polygons (i.e., the objects), and D is a preset embedding dimension (i.e., 128).

Finally, the processor 12 performs a self-attention calculation on the aforementioned [M,D] tensor to generate the map tensor, the map tensor represents relationships between the objects in the scene. In some embodiments, when transforming data of an i-th polygon in the tensor (i.e., a [1,D] vector corresponding to the i-th polygon in the [M,D] map tensor) into a query vector to perform a self-attention calculation, the processor 12 transforms at least one polygon vector corresponding to at least one surrounding polygon nearby the i-th polygon and the relationship between the i-th polygon and the surrounding polygon into key vectors and value vectors, wherein the relationship comprises a relative distance, a direction and an orientation of the surrounding polygon in the local coordinate system.

It is noticed that, the calculation of map tensor can also be executed by other apparatus previously.

Furthermore, when the obstacle-map attention layer transforms data of an i-th obstacle in the output tensor of the time attention layer (i.e., a [1,1,D] vector corresponding to the i-th obstacle in the [A,1,D] tensor) into a query vector to perform an attention calculation, the processor 12 transforms the relative distance, the direction and the orientation of the surrounding polygon in the local coordinate system of the i-th obstacle into the key vector and value vector for calculation, wherein the surrounding polygon is at least one object within 50 meters from the i-th obstacle.

The obstacle attention layer is configured to perform self-attention calculation based on the output tensor of the obstacle-map attention layer to generate an output tensor. The output tensor of the obstacle attention layer represents relationships between the obstacles.

In some embodiments, the processor 12 transforms the output tensor of the obstacle-map attention layer into query vectors, key vectors, and value vectors in the self-attention calculation of the obstacle attention layer. Also, the processor 12 performs the attention calculation of the obstacle attention layer based on the query vectors, key vectors, and value vectors. Accordingly, since the tensor with only [A,1,D] size (i.e., the output tensor of the obstacle-map attention layer) is transformed into the query vectors, key vectors, and the value vectors for the self-attention calculation, the time complexity of the obstacle-map attention layer is O(A²), and the output tensor of the obstacle attention layer is a [A,1,D] tensor.

In some embodiments, when the obstacle attention layer transforms data of an i-th obstacle in the output tensor of the obstacle-map attention layer (i.e., a [1,1,D] vector corresponding to the i-th polygon in the [A,1,D] tensor) into a query vector to perform a self-attention calculation, the processor 12 transforms the relative distance, the direction and the orientation of the surrounding obstacle in the local coordinate system of the i-th obstacle into the key vector and value vector for calculation, wherein the surrounding polygon is at least one object within 50 meters from the i-th obstacle.

Finally, as shown in FIG. 4, the output of the obstacle attention layer can be taken as a scene encoding. Accordingly, the scene encoding comprises relationships of the obstacles between different time points, relationships between the obstacles and the objects, and relationships between the obstacles. Furthermore, the scene encoding is configured to be inputted into a corresponding trajectory prediction decoder (e.g., the trajectory prediction decoder DC shown in FIG. 1) to generate a trajectory prediction result corresponding to the obstacles in the scene based on information in the scene. The time complexity of calculating the scene encoding is O(AT+AM+A²), comparing to the prior art, the time complexity is decreased by multiples of T dimension (i.e., the number of time points).

In some embodiments, the aforementioned scene encoding corresponds to the current time point (can be also recognized as the time point corresponding to the current obstacle tensor). Therefore, the scene encoding generating apparatus 1 concatenates the scene encoding corresponding to the current time point and the scene encoding corresponding to the past time point first, and then inputting the concatenated scene encoding into the trajectory prediction decoder to generate a trajectory prediction result.

For example, the scene encoding generating apparatus 1 performs a trajectory prediction based on information in the scene in the past 5 seconds. After generating a scene encoding in each of the aforementioned operations, the scene encoding generating apparatus 1 further stores the scene encoding while inputting the scene encoding into the trajectory prediction decoder to generate the trajectory prediction result. Accordingly, after generating the aforementioned scene encoding based on the current time point, the scene encoding generating apparatus 1 concatenates the scene encoding generated and the scene encoding corresponding to the past 5 seconds (e.g., 49 scene encodings generated every 100 milliseconds in the past 5 seconds) and inputs the concatenated scene encoding into the trajectory prediction decoder to generate the trajectory prediction result based on the scene situation in the past 5 seconds.

In summary, the scene encoding generating apparatus 1 can generate a scene encoding representing the relationship between the obstacles and map objects in the scene based on positions and movement states of the obstacles and the map objects in the local coordinate system corresponding to itself. In the meantime, the scene encoding generating apparatus 1 does not need to normalize coordinate systems corresponding to different time points to refer to the relationships between the obstacles and/or the map objects in the attention calculation. Accordingly, the scene encoding generating apparatus 1 can significantly reduce the time complexity for calculating the scene encoding.

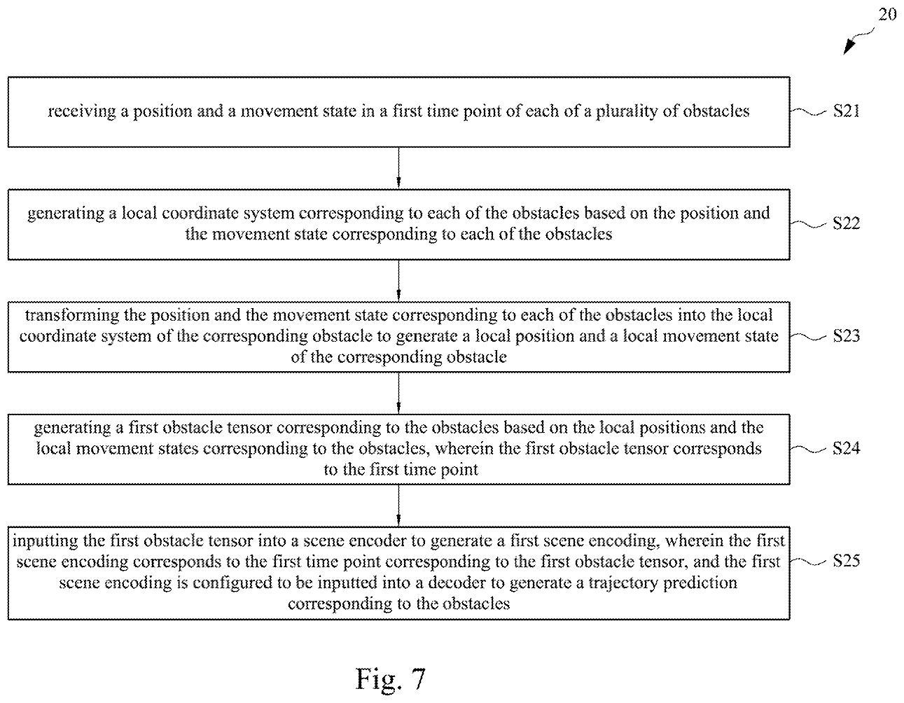

Please refer to FIG. 7, which is a schematic diagram illustrating a scene encoding generating method 20 according to a second embodiment of the present disclosure. The scene encoding generating method 20 comprises steps S21-S25. The scene encoding generating method 20 is adapted for use in a scene encoding generating apparatus (e.g., the scene encoding generating apparatus 1). The scene encoding generating apparatus is configured to generate a scene encoding for trajectory predictions based on positions and movement states of obstacles and objects in the scene.

In the step S21, the scene encoding generating apparatus receives a position and a movement state in a first time point of each of a plurality of obstacles.

In the step S22, the scene encoding generating apparatus generates a local coordinate system corresponding to each of the obstacles based on the position and the movement state corresponding to each of the obstacles.

In the step S23, the scene encoding generating apparatus transforms the position and the movement state corresponding to each of the obstacles into the local coordinate system of the corresponding obstacle to generate a local position and a local movement state of the corresponding obstacle.

In the step S24, the scene encoding generating apparatus generates a first obstacle tensor corresponding to the obstacles based on the local positions and the local movement states corresponding to the obstacles, wherein the first obstacle tensor corresponds to the first time point.

In the step S25, the scene encoding generating apparatus inputs the first obstacle tensor into a scene encoder to generate a first scene encoding, wherein the first scene encoding corresponds to the first time point corresponding to the first obstacle tensor, and the first scene encoding is configured to be inputted into a decoder to generate a trajectory prediction corresponding to the obstacles.

In some embodiments, the scene encoder comprises a time attention layer, the time attention layer is configured to perform an attention calculation based on a first input tensor corresponding to the first time point and at least one second input tensor corresponding to at least one second time point to generate a first output tensor.

In some embodiments, the scene encoding generating method 20 further comprises the scene encoding generating apparatus generating at least one query vector of the time attention layer based on the first input tensor; the scene encoding generating apparatus generating at least one key vector and at least one value vector of the time attention layer based on the second input tensor; and the scene encoding generating apparatus performing the attention calculation based on the at least one query vector, the at least one key vector, and the at least one value vector; wherein the at least one second time point is earlier than the first time point.

In some embodiments, the scene encoder comprises an obstacle-map attention layer, the obstacle-map attention layer is configured to perform an attention calculation based on a third input tensor corresponding to the obstacles and a fourth input tensor corresponding to at least one map object to generate a second output tensor.

In some embodiments, the fourth input tensor is generated after performing a self-attention calculation based on at least one polygon and at least one position corresponding to the at least one map object.

In some embodiments, the scene encoding generating method 20 further comprises the scene encoding generating apparatus generating at least one query vector of the obstacle-map attention layer based on the third input tensor; the scene encoding generating apparatus generating at least one key vector and at least one value vector of the obstacle-map attention layer based on the fourth input tensor; and the scene encoding generating apparatus performing the self-attention calculation based on the at least one query vector, the at least one key vector, and the at least one value vector.

In some embodiments, the scene encoder comprises an obstacle attention layer, the obstacle attention layer is configured to perform a self-attention calculation based on a fifth input tensor corresponding to the obstacles to generate a third output tensor.

In some embodiments, the scene encoding generating method 20 further comprises the scene encoding generating apparatus generating at least one query vector, at least one key vector, and at least one value vector of the obstacle attention layer based on the fifth input tensor; and the scene encoding generating apparatus performing the self-attention calculation based on the at least one query vector, the at least one key vector, and the at least one value vector.

In some embodiments, the scene encoding generating method 20 further comprises the scene encoding generating apparatus concatenating the first scene encoding corresponding to the first time point and at least one second scene encoding corresponding to at least one second time point to generate an output scene encoding, wherein the output scene encoding is configured to be inputted into the decoder to generate the trajectory prediction corresponding to the obstacles.

In some embodiments, the at least one second scene encoding is generated after inputting at least one second obstacle tensor corresponding to the at least one second time point into the scene encoder.

In summary, the scene encoding generating method 20 can generate a scene encoding representing the relationship between the obstacles and map objects in the scene based on positions and movement states of the obstacles and the map objects in the local coordinate system corresponding to itself. In the meantime, the scene encoding generating method 20 does not need to normalize coordinate systems corresponding to different time points to refer to the relationships between the obstacles and/or the map objects in the attention calculation. Accordingly, the scene encoding generating method 20 can significantly reduce the time complexity for calculating the scene encoding.

The scene encoding generating method described in the second embodiment may be implemented by a computer program having a plurality of codes. The computer program may be a file that can be transmitted over the network, or may be stored into a non-transitory computer readable storage medium. After the codes of the computer program are loaded into an electronic apparatus (e.g., the scene encoding generating apparatus 1), the computer program executes the scene encoding generating method as described in the second embodiment. The non-transitory computer readable storage medium may be an electronic product, e.g., a read only memory (ROM), a flash memory, a floppy disk, a hard disk, a compact disk (CD), a mobile disk, a database accessible to networks, or any other storage medium with the same function and well known to those of ordinary skill in the art.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A scene encoding generating apparatus, comprising:
a communication interface; and
a processor, coupled to the communication interface, and the processor is configured to execute the following operations:
receiving a position and a movement state in a first time point of each of a plurality of obstacles;
generating a local coordinate system corresponding to each of the obstacles based on the position and the movement state corresponding to each of the obstacles;
transforming the position and the movement state corresponding to each of the obstacles into the local coordinate system of the corresponding obstacle to generate a local position and a local movement state of the corresponding obstacle;
generating a first obstacle tensor corresponding to the obstacles based on the local positions and the local movement states corresponding to the obstacles, wherein the first obstacle tensor corresponds to the first time point; and
inputting the first obstacle tensor into a scene encoder to generate a first scene encoding, wherein the first scene encoding corresponds to the first time point corresponding to the first obstacle tensor, and the first scene encoding is configured to be inputted into a decoder to generate a trajectory prediction corresponding to the obstacles.

2. The scene encoding generating apparatus of claim 1, wherein the scene encoder comprises a time attention layer, the time attention layer is configured to perform an attention calculation based on a first input tensor corresponding to the first time point and at least one second input tensor corresponding to at least one second time point to generate a first output tensor.

3. The scene encoding generating apparatus of claim 2, wherein the processor is further configured to execute the following operations:
generating at least one query vector of the time attention layer based on the first input tensor;
generating at least one key vector and at least one value vector of the time attention layer based on the second input tensor; and
performing the attention calculation based on the at least one query vector, the at least one key vector, and the at least one value vector;
wherein the at least one second time point is earlier than the first time point.

4. The scene encoding generating apparatus of claim 1, wherein the scene encoder comprises an obstacle-map attention layer, the obstacle-map attention layer is configured to perform an attention calculation based on a third input tensor corresponding to the obstacles and a fourth input tensor corresponding to at least one map object to generate a second output tensor.

5. The scene encoding generating apparatus of claim 4, wherein the fourth input tensor is generated after performing a self-attention calculation based on at least one polygon and at least one position corresponding to the at least one map object.

6. The scene encoding generating apparatus of claim 4, wherein the processor is further configured to execute the following operations:
generating at least one query vector of the obstacle-map attention layer based on the third input tensor;
generating at least one key vector and at least one value vector of the obstacle-map attention layer based on the fourth input tensor; and
performing the attention calculation based on the at least one query vector, the at least one key vector, and the at least one value vector.

7. The scene encoding generating apparatus of claim 1, wherein the scene encoder comprises an obstacle attention layer, the obstacle attention layer is configured to perform a self-attention calculation based on a fifth input tensor corresponding to the obstacles to generate a third output tensor.

8. The scene encoding generating apparatus of claim 7, wherein the processor is further configured to execute the following operations:
generating at least one query vector, at least one key vector, and at least one value vector of the obstacle attention layer based on the fifth input tensor; and
performing the self-attention calculation based on the at least one query vector, the at least one key vector, and the at least one value vector.

9. The scene encoding generating apparatus of claim 1, wherein the processor is further configured to execute the following operations:
concatenating the first scene encoding corresponding to the first time point and at least one second scene encoding corresponding to at least one second time point to generate an output scene encoding, wherein the output scene encoding is configured to be inputted into the decoder to generate the trajectory prediction corresponding to the obstacles.

10. The scene encoding generating apparatus of claim 9, wherein the at least one second scene encoding is generated after inputting at least one second obstacle tensor corresponding to the at least one second time point into the scene encoder.

11. A scene encoding generating method, being adapted for use in a scene encoding generating apparatus, wherein the scene encoding generating method comprises the following steps:
receiving, by the scene encoding generating apparatus, a position and a movement state in a first time point of each of a plurality of obstacles;
generating, by the scene encoding generating apparatus, a local coordinate system corresponding to each of the obstacles based on the position and the movement state corresponding to each of the obstacles;
transforming, by the scene encoding generating apparatus, the position and the movement state corresponding to each of the obstacles into the local coordinate system of the corresponding obstacle to generate a local position and a local movement state of the corresponding obstacle;
generating, by the scene encoding generating apparatus, a first obstacle tensor corresponding to the obstacles based on the local positions and the local movement states corresponding to the obstacles, wherein the first obstacle tensor corresponds to the first time point; and
inputting, by the scene encoding generating apparatus, the first obstacle tensor into a scene encoder to generate a first scene encoding, wherein the first scene encoding corresponds to the first time point corresponding to the first obstacle tensor, and the first scene encoding is configured to be inputted into a decoder to generate a trajectory prediction corresponding to the obstacles.

12. The scene encoding generating method of claim 11, wherein the scene encoder comprises a time attention layer, the time attention layer is configured to perform an attention calculation based on a first input tensor corresponding to the first time point and at least one second input tensor corresponding to at least one second time point to generate a first output tensor.

13. The scene encoding generating method of claim 12, further comprising:
generating at least one query vector of the time attention layer based on the first input tensor;
generating at least one key vector and at least one value vector of the time attention layer based on the second input tensor; and
performing the attention calculation based on the at least one query vector, the at least one key vector, and the at least one value vector;
wherein the at least one second time point is earlier than the first time point.

14. The scene encoding generating method of claim 11, wherein the scene encoder comprises an obstacle-map attention layer, the obstacle-map attention layer is configured to perform an attention calculation based on a third input tensor corresponding to the obstacles and a fourth input tensor corresponding to at least one map object to generate a second output tensor.

15. The scene encoding generating method of claim 14, wherein the fourth input tensor is generated after performing a self-attention calculation based on at least one polygon and at least one position corresponding to the at least one map object.

16. The scene encoding generating method of claim 14, further comprising:
generating at least one query vector of the obstacle-map attention layer based on the third input tensor;
generating at least one key vector and at least one value vector of the obstacle-map attention layer based on the fourth input tensor; and
performing the attention calculation based on the at least one query vector, the at least one key vector, and the at least one value vector.

17. The scene encoding generating method of claim 11, wherein the scene encoder comprises an obstacle attention layer, the obstacle attention layer is configured to perform a self-attention calculation based on a fifth input tensor corresponding to the obstacles to generate a third output tensor.

18. The scene encoding generating method of claim 17, further comprising:
generating at least one query vector, at least one key vector, and at least one value vector of the obstacle attention layer based on the fifth input tensor; and
performing the self-attention calculation based on the at least one query vector, the at least one key vector, and the at least one value vector.

19. The scene encoding generating method of claim 11, further comprising:
concatenating the first scene encoding corresponding to the first time point and at least one second scene encoding corresponding to at least one second time point to generate an output scene encoding, wherein the output scene encoding is configured to be inputted into the decoder to generate the trajectory prediction corresponding to the obstacles.

20. A non-transitory computer readable storage medium, having a computer program stored therein, wherein the computer program comprises a plurality of codes, the computer program executes a scene encoding generating method after being loaded into an electronic apparatus, the scene encoding generating method comprises:
receiving, by the electronic apparatus, a position and a movement state in a first time point of each of a plurality of obstacles;
generating, by the electronic apparatus, a local coordinate system corresponding to each of the obstacles based on the position and the movement state corresponding to each of the obstacles;
transforming, by the electronic apparatus, the position and the movement state corresponding to each of the obstacles into the local coordinate system of the corresponding obstacle to generate a local position and a local movement state of the corresponding obstacle;
generating, by the electronic apparatus, a first obstacle tensor corresponding to the obstacles based on the local positions and the local movement states corresponding to the obstacles, wherein the first obstacle tensor corresponds to the first time point; and
inputting, by the electronic apparatus, the first obstacle tensor into a scene encoder to generate a first scene encoding, wherein the first scene encoding corresponds to the first time point corresponding to the first obstacle tensor, and the first scene encoding is configured to be inputted into a decoder to generate a trajectory prediction corresponding to the obstacles.
